(19) United States
(12) Patent Application Publication
(10) Pub. No.: US 2015/0321610 A1
(43) Pub. Date: Nov. 12, 2015

(54) Rear Backup Sideview Mirror Assembly

(71) Applicant: Walter Lee Nichols, Memphis, TN (US)

(72) Inventor: Walter Lee Nichols, Memphis, TN (US)

(21) Appl. No.: 14/680,415

(22) Filed: Apr. 7, 2015

Related U.S. Application Data
(60) Provisional application No. 61/996,493, filed on May 8, 2014.

(51) Int. Cl. B60R 1/08; B60R 1/06; B60R 1/04

(52) U.S. Cl. CPC B60R 1/081; B60R 1/04; B60R 1/06

(57) ABSTRACT

A rear backup sideview mirror assembly to be used in conjunction with a vehicle's interior or exterior rearview mirrors to view other motor vehicles moving in a side to lateral direction.

### CROSS-REFERENCE TO RELATED APPLICATIONS

| | | |
|---|---|---|
| 61/996,493 | May, 2014 | Nichols |
| 7,780,299 | August, 2010 | Martinson |
| 7,422,337 | September, 2008 | Fetherston |
| 7,147,335 | December, 2006 | Dickenson |
| 6,979,089 | December, 2005 | Martinson |
| 6,799,857 | March, 2005 | Morrison |
| 6,799,857 | October, 2005 | Martinson |
| 6,715,893 | April, 2005 | Martinson |
| 2002/0186481 | December, 2005 | Martinson |

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC

Not Applicable

### DESCRIPTION

1. Field of the Invention

This disclosure relates to an apparatus that allows the driver of a vehicle to obtain the view of incoming traffic where the incoming traffic would be headed toward the passenger's side or driver's side of the vehicle when the vehicle operated in reverse, with the use of a rear backup sideview mirror assembly.

2. Background of the Invention

This application is a Nonprovisional Application of the Provisional Application filed under U.S. Patent Application No. 61/996,493 filed May 8, 2014. The benefit of the earlier filing date of the aforementioned Provisional U.S. Patent Application No. 61/996,493 is hereby claimed.

When the driver of a vehicle operates said vehicle in reverse, the driver does not always have a clear view of oncoming traffic, for instance, when the vehicle is parked between two cars in a parking lot. In this instance, the driver's view is obstructed by the vehicles on either side of the vehicle the driver is operating and the driver cannot see oncoming traffic. The present disclosure reveals an apparatus that when used in conjunction with any of the existing vehicle rearview mirror, driver's sideview mirror, or passenger's sideview mirror, would allow the driver a perspective of oncoming traffic that would otherwise collide with driver's vehicle.

Several attempts have been made to create lateral view mirror assemblies, all of which can be distinguished from the present disclosure:

In U.S. Pat. No. 7,780,299, Martinson discloses a lateral view mirror assembly for attachment to the rear of a vehicle in order to obtain lateral views of oncoming traffic, whereas the present disclosure reveals an apparatus that attaches to the rear of a vehicle in order to obtain lateral views of oncoming traffic as well as an additional view of traffic coming from the rear, which is otherwise partially obstructed by the apparatus.

In U.S. Pat. No. 7,422,337, Fetherston discloses a lateral view mirror assembly for attachment to the rear of a vehicle in order to obtain lateral views of oncoming traffic, along with a leveling means for the same, whereas the present disclosure reveals an apparatus that attaches to the rear of a vehicle in order to obtain lateral views of oncoming traffic as well as an additional view of traffic coming from the rear, which is otherwise partially obstructed by the apparatus.

In U.S. Pat. No. 7,147,335, Dickinson discloses a pair of lateral view mirror assemblies for attachment to the driver's side rear of a vehicle or the passenger's side rear of the vehicle in order to obtain lateral views of oncoming traffic, whereas the present disclosure reveals a single apparatus that attaches to either the driver's side rear of a vehicle or the passenger's side rear of the vehicle in order to obtain lateral views of oncoming traffic.

In U.S. Pat. No. 6,979,089, Martinson discloses a pair of mirror assemblies for use with minivans and SUV's that are attached on the inside of the vehicle, to be used with the rearview mirror, that allows the driver a view laterally and downwardly, whereas the present apparatus is a single apparatus attached to the exterior of a vehicle, used in conjunction with either the rearview mirror, driver's sideview mirror, or passenger's sideview mirror, that allows the driver to obtain to obtain lateral views of oncoming traffic.

In U.S. Pat. No. 6,871,971, Morrison discloses a mirror attached inside a vehicle that provides the user with an oblique angle of oncoming traffic, whereas the present apparatus is a single apparatus attached to the exterior of a vehicle, used in conjunction with either the rearview mirror, driver's sideview mirror, or passenger's sideview mirror, that allows the driver to obtain to obtain lateral views of oncoming traffic.

In U.S. Pat. No. 6,799,857, Martinson discloses a pair of mirrors used in conjunction with the rearview mirror that allows the driver to obtain to obtain lateral views of oncoming traffic, whereas the present apparatus is a single apparatus attached to the exterior of a vehicle, used in conjunction with either the rearview mirror, driver's sideview mirror, or passenger's sideview mirror, that allows the driver to obtain to obtain lateral views of oncoming traffic.

In U.S. Pat. No. 6,715,893, Martinson discloses a pair of mirrors used in conjunction with the rearview mirror that allows the driver to obtain to obtain lateral views of oncoming traffic, whereas the present apparatus is a single apparatus attached to the exterior of a vehicle, used in conjunction with either the rearview mirror, driver's sideview mirror, or passenger's sideview mirror, that allows the driver to obtain to obtain lateral views of oncoming traffic.

In U.S. Pat. App. No 2002/01864810 Martinson discloses a mirror assembly to be used with the rearview mirror that is attached to the rear of a vehicle that allows the driver to obtain to obtain lateral views of oncoming traffic, whereas the present disclosure reveals an apparatus that attaches to the rear of a vehicle in order to obtain lateral views of oncoming traffic as well as an additional view of traffic coming from the rear, which is otherwise partially obstructed by the apparatus. Martinson also reveals a pair of mirrors attached to the outside driver's side rear of the vehicle and the passerger's side rear of a vehicle, that allow the driver to obtain to obtain lateral views of oncoming traffic, whereas the present apparatus is a single apparatus attached to the exterior of a vehicle, used in conjunction with either the driver's sideview mirror or passenger's sideview mirror, that allows the driver to obtain to obtain lateral views of oncoming traffic.

### SUMMARY OF THE INVENTION

The present disclosure is a rear backup sideview mirror assembly to enable the driver of the vehicle to see the lateral views from the back of a vehicle to aid in the prevention of accidents when operating the vehicle in reverse.

The first embodiment of the rear backup sideview mirror assembly is a rearview mirror assembly wherein the driver of the vehicle can look into the rearview mirror of the vehicle and obtain perspectives of oncoming traffic toward the driver's side of the vehicle, toward the passenger's side of the vehicle, and a downward perspective to see if anything is behind the vehicle but out of the driver's view.

The second embodiment of the rear backup sideview mirror assembly is a driver's sideview mirror assembly wherein the driver of the vehicle can look into the driver's sideview mirror of the vehicle and obtain perspectives of oncoming traffic toward the driver's side of the vehicle or toward the passenger's side of the vehicle.

The third embodiment of the rear backup sideview mirror assembly is a passenger's sideview mirror assembly wherein the driver of the vehicle can look into the passenger's's sideview mirror of the vehicle and obtain perspectives of oncoming traffic toward the driver's side of the vehicle or toward the passenger's side of the vehicle.

The base of the any of the three revealed embodiments is attached to the vehicle by a plurality of attachment means, which could include a plurality of threaded fasters, a plurality of suction cups, a plurality of magnets or a plurality of straps. Any of the plurality of mirrors may be adjustable to optimize the view of oncoming traffic once the rear backup sideview mirror assembly is attached to the vehicle. Any of the plurality of mirrors may also be convex.

### BRIEF DESCRIPTION OF THE SEVERAL VIEWS OF THE DRAWING

FIG. 1A is a view of the first embodiment of the rear backup sideview mirror assembly, the rearview mirror assembly;

FIG. 1B is a view of the rearview mirror assembly with convex mirrors and where the plurality of mirrors are adjustable;

FIG. 1C is a view of the rearview mirror assembly in association with the rearview mirror of the vehicle, indicating the perspective visible to the driver relative to the driver's side lateral mirror and the passenger's side lateral mirror;

FIG. 1D is a view of the rearview mirror assembly in association with the rearview mirror of the vehicle, indicating the downward perspective visible to the driver relative to the rear assembly mirror;

FIG. 1E is a view of the underside of the rearview mirror assembly indicating the location of some of the plurality of attachment means;

FIG. 1F is a view of the rearview mirror assembly indicating as it is attached to a vehicle by a plurality of straps;

FIG. 2A is a view of the second embodiment of the rear backup sideview mirror assembly, the driver's sideview mirror assembly;

FIG. 2B is a view of the driver's sideview mirror assembly with convex mirrors and where the plurality of mirrors are adjustable;

FIG. 2C is a view of the driver's sideview mirror assembly in association with the rearview mirror of the vehicle, indicating the perspective visible to the driver relative to the driver's side lateral mirror and the passenger's side lateral mirror;

FIG. 2D is a view of the underside of the driver's sideview mirror assembly indicating the location of some of the plurality of attachment means;

FIG. 2E is a view of the driver's sideview mirror assembly indicating as it is attached to a vehicle by a plurality of straps;

FIG. 3A is a view of the third embodiment of the rear backup sideview mirror assembly, the passenger's side mirror assembly;

FIG. 3B is a view of the passenger's side mirror assembly with convex mirrors and where the plurality of mirrors are adjustable;

FIG. 3C is a view of the passenger's side mirror assembly in association with the rearview mirror of the vehicle, indicating the perspective visible to the driver relative to the driver's side lateral mirror and the passenger's side lateral mirror;

FIG. 3D is a view of the underside of the passenger's side mirror assembly indicating the location of some of the plurality of attachment means;

FIG. 3E is a view of the passenger's side mirror assembly indicating as it is attached to a vehicle by a plurality of straps;

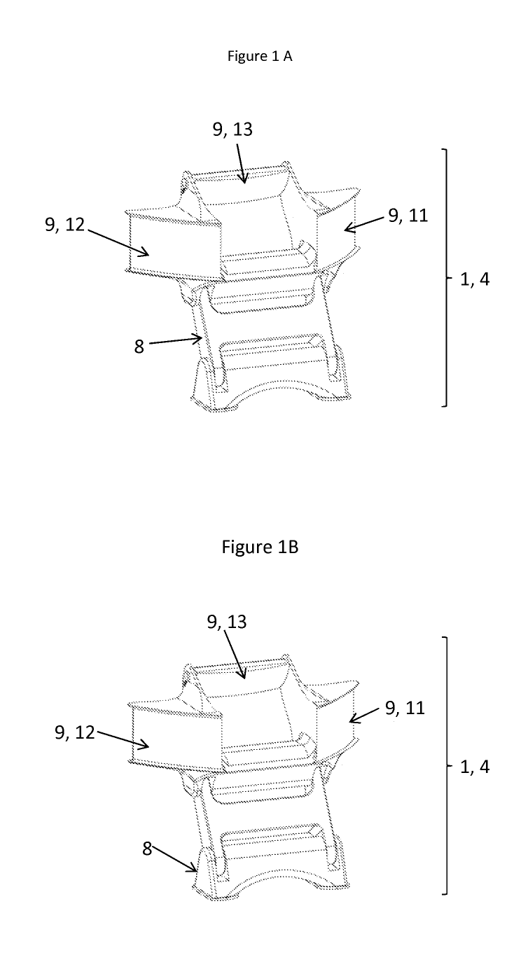

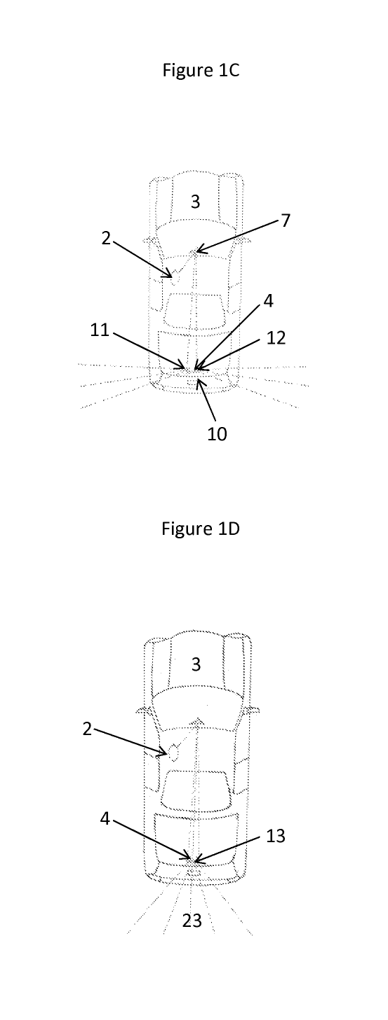

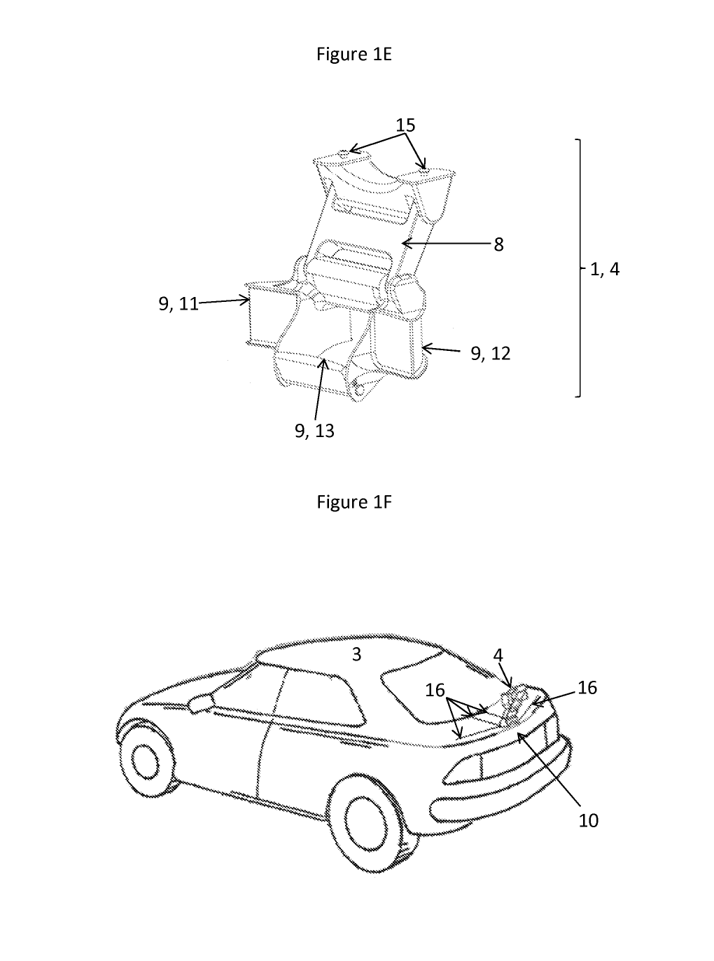

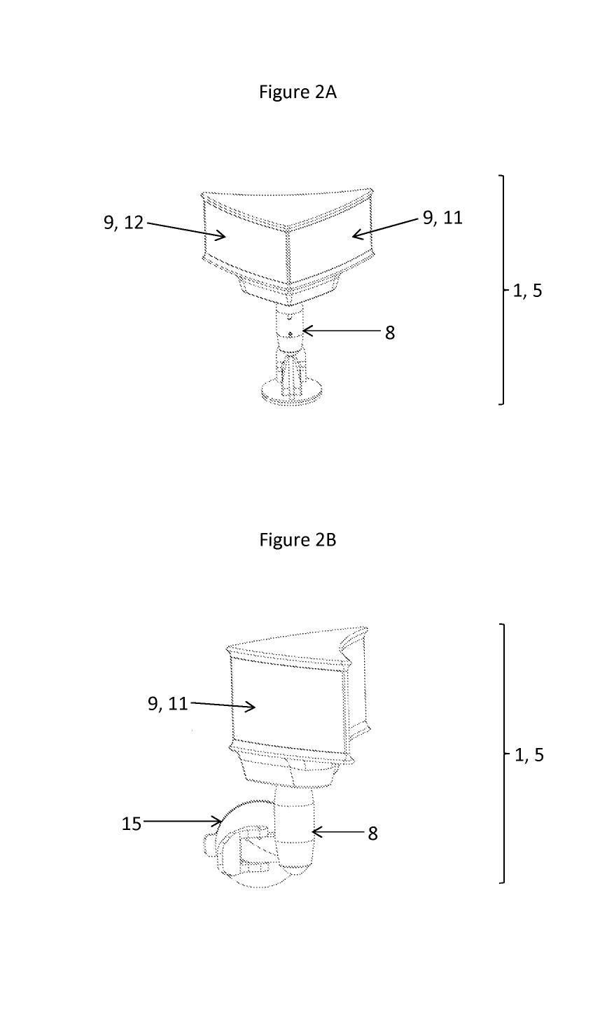

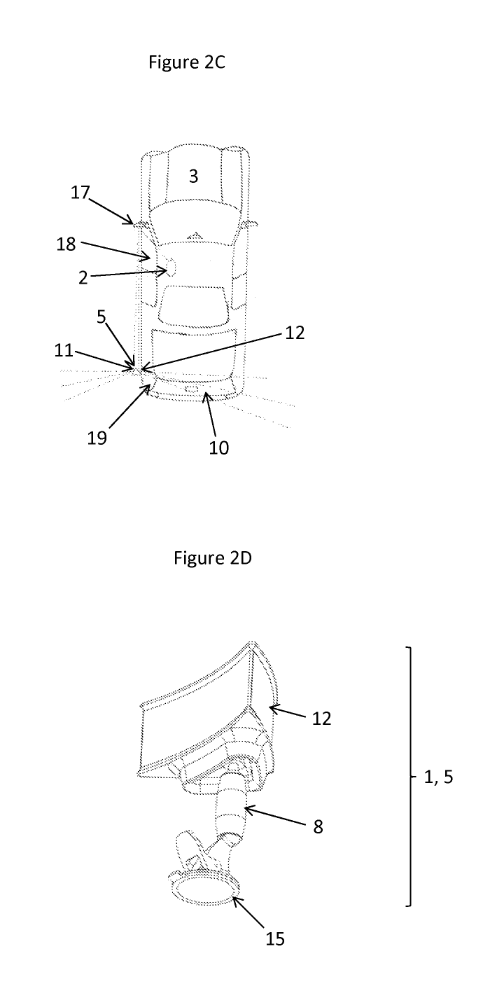

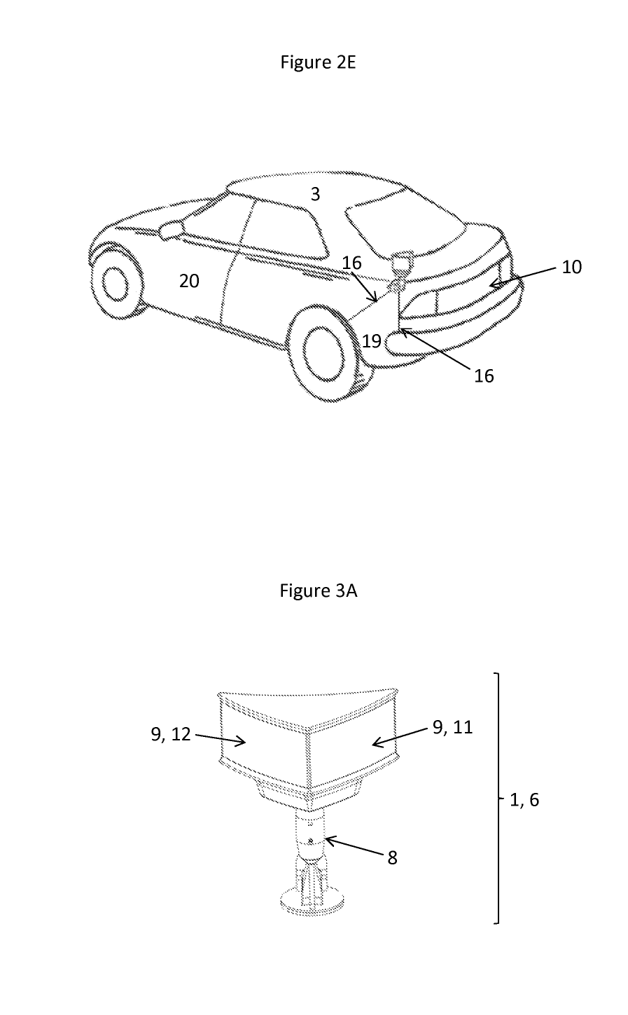

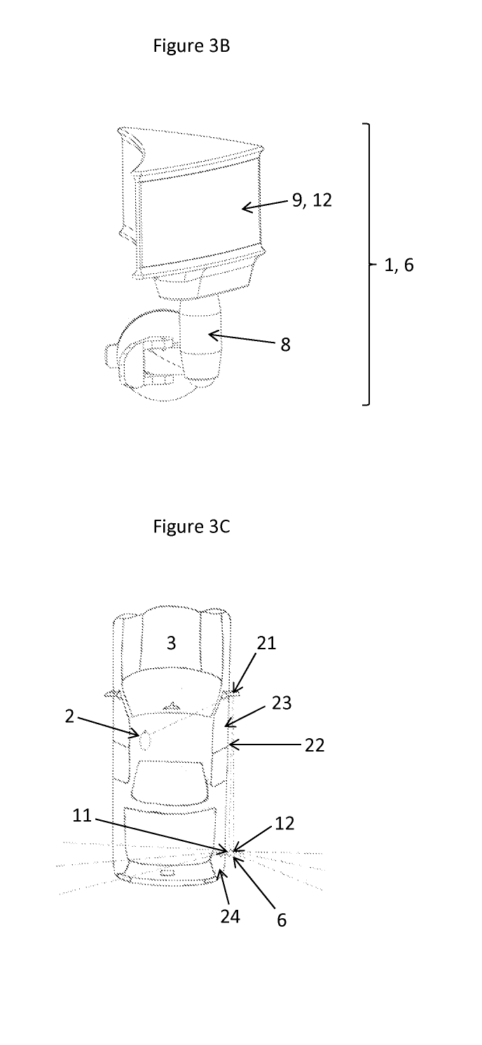

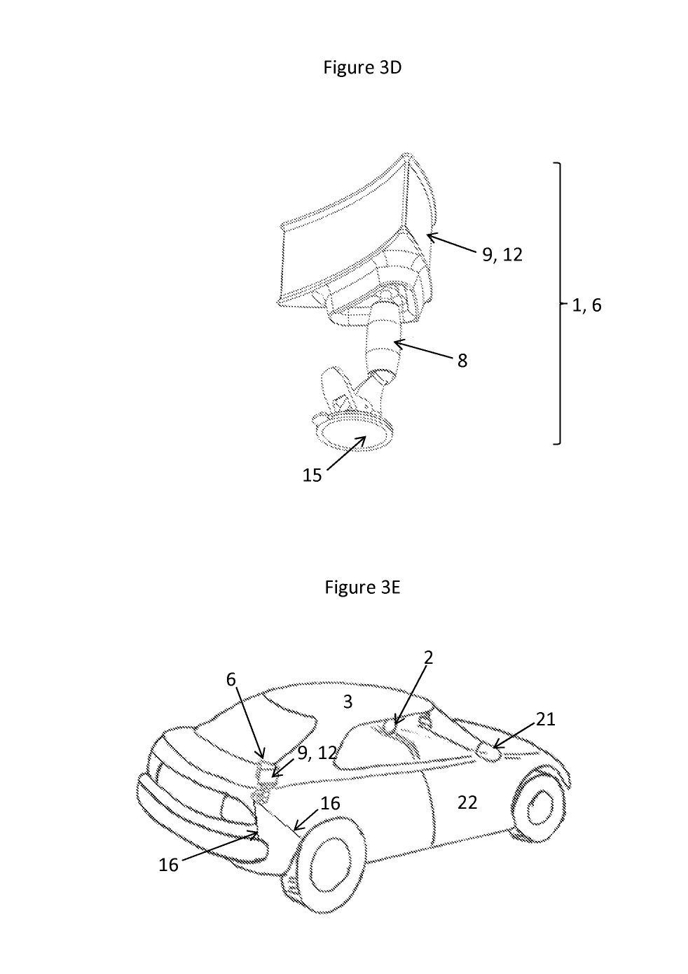

### DETAILED DESCRIPTION OF THE INVENTION

A rear backup sideview mirror assembly 1 to enable the driver 2 of a vehicle 3 to see the lateral views from the back of the vehicle 3 to aid in the prevention of accidents when operating the vehicle 3 in reverse wherein there are three embodiments, a rearview mirror assembly 4, a driver's sideview mirror assembly 5 and a passenger's sideview mirror assembly 6.

The first embodiment 4 of the rear backup side view mirror assembly 1 is a rearview mirror assembly 4 that comprises a rearview mirror 7, a base 8 and a plurality of mirrors 9, wherein the driver 2 of the vehicle 3 can look into the rearview mirror 7 of the vehicle 3 and obtain the perspectives from the mirrors attached to the base 8. In this embodiment, the rearview mirror 7 is located centrally in the front window, within the compartment of a vehicle 3 and the base 8 and associated plurality of mirrors 9 are attached to the rear 10 of said vehicle 3. The first of the plurality of mirrors 9 is a driver's side lateral mirror 11. The second of the plurality of mirrors 9 is a passenger's side lateral mirror 12. The third of the plurality of mirrors 9 is the rear assembly mirror 13.

In the first embodiment 4, the driver's side lateral mirror 11 is positioned on the base 8 such that, when the driver 2 of the vehicle 3 looks into the rearview mirror 7, the view of the driver 2 includes the driver's side lateral mirror 11 and the perspective presented to the driver 2 from the driver's side lateral mirror 11 is of potential oncoming traffic heading towards the driver's side of the vehicle 3. In the first embodiment 4, the passenger's side lateral mirror 12 is positioned on the base 8 such that, when the driver 2 of the vehicle 3 looks into the rearview mirror 7, the view of the driver 2 includes the passenger's side lateral mirror 12 and the perspective presented to the driver 2 from the passenger's side lateral mirror 12 is of potential oncoming traffic heading towards the passenger's side of the vehicle 3.

The rear assembly mirror 13 faces downward such that, when the driver 2 looks into the rearview mirror 7, the perspective presented to the driver 2 includes the rear assembly mirror, which provides the driver 2 a view downward and behind the rear of the vehicle 3 so that the driver 2 can see if something is behind the vehicle 3 but not otherwise visible.

The base 8 of the rearview mirror assembly 4 is attached to the rear 10 of the vehicle 3 by a plurality of attachment means 15, which could include a plurality of threaded fasters, a plurality of suction cups, a plurality of magnets or a plurality of straps 16. Any of the plurality of mirrors 9 may be adjustable to optimize the view of oncoming traffic once the rear backup side view mirror assembly 1 is attached to the vehicle 3. Any of the plurality of mirrors 9 may also be convex.

The second embodiment 5 of the rear backup side view mirror assembly 1 is a driver's sideview mirror assembly that comprises a driver's side mirror 17, a base 8 and a plurality of mirrors 9, wherein the driver 2 of the vehicle 3 can look into the driver's side mirror 17 of the vehicle 3 and obtain the perspectives from the plurality of mirrors 9 attached to the base 8. In this embodiment the driver's side mirror 17 is located on the exterior, driver's side of the vehicle 3 forward of the driver's door window 18 and the base 8, with the plurality of mirrors 9, attached to the base 8 is attached to the driver's side rear 19 of said vehicle 3. The first of the plurality of mirrors 9 is a driver's side lateral mirror 11. The second of the plurality of mirrors 9 is a passenger's side lateral mirror 12.

In the second embodiment 5, the driver's side lateral mirror 11 is positioned on the base 8 such that, when the driver 2 of the vehicle 3 looks into the driver's side mirror 17, the view of the driver 2 includes the driver's side lateral mirror 11 and the perspective presented to the driver 2 from the driver's side lateral mirror 11 is of potential oncoming traffic heading towards the driver's side of the vehicle 3. In the second embodiment 5, the passenger's side lateral mirror 12 is positioned on the base 8 such that, when the driver 2 of the vehicle 3 looks into the driver's side mirror 17, the view of the driver 2 includes the passenger's side lateral mirror 12 and the perspective presented to the driver 2 from the passenger's side lateral mirror 12 is of potential oncoming traffic heading towards the passenger's side of the vehicle 3.

The base 8 of the driver's sideview mirror assembly 5 is attached to the rear 10 of the vehicle 3 on the driver's side 20 by a plurality of attachment means 15, which could include a plurality of threaded fasters, a plurality of suction cups, a plurality of magnets or a plurality of straps 16. Any of the plurality of mirrors 9 may be adjustable to optimize the view of oncoming traffic once the rear backup side view mirror assembly 1 is attached to the vehicle 3. Any of the plurality of mirrors 9 may also be convex.

The third embodiment 6 of the rear backup side view mirror assembly 1 is a passenger's sideview mirror assembly 6 that comprises a passenger's side mirror 21, a base 8 and a plurality of mirrors 9, wherein the driver 2 of the vehicle 3 can look into the passenger's side mirror 21 of the vehicle 3 and obtain the perspectives from the mirrors attached to the base 8. In this embodiment, the passenger's side mirror 21 is located on the exterior, passenger's side 22 of the vehicle 3 forward of the passenger's door window 23 and the base 8 and associated plurality of mirrors 9 are attached to the passenger's side rear 24 of said vehicle 3. The first of the plurality of mirrors 9 is a driver's side lateral mirror 11. The second of the plurality of mirrors 9 is a passenger's side lateral mirror 12.

In the third embodiment 6, the passenger's side lateral mirror 12 is positioned on the base 8 such that, when the driver 2 of the vehicle 3 looks into the passenger's side mirror 21, the view of the driver 2 includes the driver's side lateral mirror 11 and the perspective presented to the driver 2 from the driver's side lateral mirror 11 is of potential oncoming traffic heading towards the driver's side 20 of the vehicle 3. In the third embodiment 6, the passenger's side lateral mirror 12 is positioned on the base 8 such that, when the driver 2 of the vehicle 3 looks into the passenger's side mirror 21, the view of the driver 2 includes the passenger's side lateral mirror 12 and the perspective presented to the driver 2 from the passenger's side lateral mirror 12 is of potential oncoming traffic heading towards the passenger's side of the vehicle 3.

The base 8 of the passenger's sideview mirror assembly 6 is attached to the rear 10 of the vehicle 3 on the passenger's side 22 by a plurality of attachment means 15, which could include a plurality of threaded fasters, a plurality of suction cups, a plurality of magnets or a plurality of straps 16. Any of the plurality of mirrors 9 may be adjustable to optimize the view of oncoming traffic once the rear backup side view mirror assembly 1 is attached to the vehicle 3. Any of the plurality of mirrors 9 may also be convex.

What is claimed:

1. A rear backup sideview mirror assembly to enable the driver of the vehicle to see the lateral views from the back of a vehicle to aid in the prevention of accidents when operating the vehicle in reverse comprising:
a rearview mirror, a base and a plurality of mirrors;
wherein the rearview mirror is located centrally in the front window, within the compartment of a vehicle;
wherein the base is attached to the rear of said vehicle by a plurality of attachment means;
wherein the plurality of mirrors are attached to the base;
wherein the first of the plurality of mirrors is a driver's side lateral mirror;
wherein the second of the plurality of mirrors is a passenger's side lateral mirror;
wherein there is a third of the plurality of mirrors is a rear assembly mirror;
wherein the driver's side lateral mirror is positioned on the base such that, when the driver of the vehicle looks into the rearview mirror, the view of the driver includes the driver's side lateral mirror and the perspective presented to the driver from the driver's side lateral mirror is of potential oncoming traffic heading towards the driver's side of the vehicle;
wherein the passenger's side lateral mirror is positioned on the base such that, when the driver of the vehicle looks into the rearview mirror, the view of the driver includes the passenger's side lateral mirror and the perspective presented to the driver from the passenger's side lateral mirror is of potential oncoming traffic heading towards the passenger's side of the vehicle; and
wherein the rear assembly mirror is positioned on the base such that when the driver looks into the rearview mirror, the perspective presented to the driver includes the rear assembly mirror, which provides the driver a view downward and behind the rear of the vehicle so that the driver can see if something is behind the vehicle but not otherwise visible.

2. The rear backup sideview mirror assembly of claim 1 where at least one of the plurality of mirrors is adjustable to optimize the view of oncoming traffic once the rear backup sideview mirror assembly is attached to the vehicle.

3. The rear backup sideview mirror assembly of claim 1 where at least one of the plurality of mirrors is convex.

4. The rear backup sideview mirror assembly of claim 3 where at least one of the plurality of mirrors is adjustable to optimize the view of oncoming traffic once the rear backup sideview mirror assembly is attached to the vehicle.

5. A rear backup sideview mirror assembly to enable the driver of the vehicle to see the lateral views from the back of a vehicle to aid in the prevention of accidents when operating the vehicle in reverse comprising:
A driver's side mirror, a base and a plurality of mirrors;
wherein the driver's side mirror is located on the exterior, driver's side of the vehicle forward of the driver's door window;
wherein the base is attached to the driver's side rear of said vehicle by a plurality of attachment means;
wherein the plurality of mirrors are attached to the base;
wherein the first of the plurality of mirrors is a driver's side lateral mirror;
wherein the second of the plurality of mirrors is a passenger's side lateral mirror;
wherein the driver's side lateral mirror is positioned on the base such that, when the driver of the vehicle looks into the driver's side mirror, the view of the driver includes the driver's side lateral mirror and the perspective presented to the driver from the driver's side lateral mirror is of potential oncoming traffic heading towards the driver's side of the vehicle; and
wherein the passenger's side lateral mirror is positioned on the base such that, when the driver of the vehicle looks into the driver's side mirror, the view of the driver includes the passenger's side lateral mirror and the perspective presented to the driver from the passenger's side lateral mirror is of potential oncoming traffic heading towards the passenger's side of the vehicle.

6. The rear backup sideview mirror assembly of claim 5 where at least one of the plurality of mirrors is adjustable to optimize the view of oncoming traffic once the rear backup sideview mirror assembly is attached to the vehicle.

7. The rear backup sideview mirror assembly of claim 5 where at least one of the plurality of mirrors is convex.

8. The rear backup sideview mirror assembly of claim 7 where at least one of the plurality of mirrors is adjustable to optimize the view of oncoming traffic once the rear backup sideview mirror assembly is attached to the vehicle.

9. A rear backup sideview mirror assembly to enable the driver of the vehicle to see the lateral views from the back of a vehicle to aid in the prevention of accidents when operating the vehicle in reverse comprising:
A passenger's side mirror, a base and a plurality of mirrors;
wherein the passenger's side mirror is located on the exterior, passenger's side of the vehicle forward of the passenger's door window;
wherein the base is attached to the passenger's side rear of said vehicle by a plurality of attachment means;
wherein the plurality of mirrors are attached to the base;
wherein the first of the plurality of mirrors is a driver's side lateral mirror;
wherein the second of the plurality of mirrors is a passenger's side lateral mirror;
wherein the passenger's side lateral mirror is positioned on the base such that, when the driver of the vehicle looks into the passenger's side mirror, the view of the driver includes the driver's side lateral mirror and the perspective presented to the driver from the driver's side lateral mirror is of potential oncoming traffic heading towards the driver's side of the vehicle; and
wherein the passenger's side lateral mirror is positioned on the base such that, when the driver of the vehicle looks into the passenger's side mirror, the view of the driver includes the passenger's side lateral mirror and the perspective presented to the driver from the passenger's side lateral mirror is of potential oncoming traffic heading towards the passenger's side of the vehicle.

10. The rear backup sideview mirror assembly of claim 9 where at least one of the plurality of mirrors is adjustable to optimize the view of oncoming traffic once the rear backup sideview mirror assembly is attached to the vehicle.

11. The rear backup sideview mirror assembly of claim 9 where at least one of the plurality of mirrors is convex.

12. The rear backup sideview mirror assembly of claim 11 where at least one of the plurality of mirrors is adjustable to optimize the view of oncoming traffic once the rear backup sideview mirror assembly is attached to the vehicle.
